(19) United States
(12) Patent Application Publication
(10) Pub. No.: US 2012/0235967 A1
(43) Pub. Date: Sep. 20, 2012

(54) DISPLAY DEVICE

(75) Inventors: Hiromi Katoh, Osaka (JP); Naru Usukura, Osaka (JP); Masahiro Ueda, Osaka (JP)

(73) Assignee: Sharp Kabushiki Kaisha, Osaka (JP)

(21) Appl. No.: 13/512,411

(22) PCT Filed: Nov. 30, 2010
(86) PCT No.: PCT/JP2010/071317

§ 371 Date: May 29, 2012

(30) Foreign Application Priority Data
Nov. 30, 2009 (JP) 2009-272649

(51) Int. Cl. G09G 5/10

(52) U.S. Cl. 345/207

(57) ABSTRACT

Provided is a display device that can determine an event in accordance with an input operation without using a complex circuit configuration for image processing by simplifying a difference image processing. The display device is provided with a driver circuit for outputting a first control signal, which indicates a first detection period including an ON period of a light source, and a second control signal, which indicates a second detection period not including the ON period of the light source, and performing reset and read-out operations for sensor pixel circuits. The display device is further provided with a difference circuit 21 for deriving pixel values that indicate differences between outputs from the sensor pixel circuits, which correspond to charges that have been accumulated in accordance with incident light during the first detection period, and outputs from the sensor pixel circuits, which correspond to charges that have been accumulated in accordance with incident light during the second detection period, a histogram creating unit 22 for extracting a histogram from the pixel values that have been derived by the difference circuit 21, and an operation determining unit 23 for determining an operation in accordance with an input through an optical sensor on the basis of the histogram.

### TECHNICAL FIELD

The present invention relates to a display device, and more particularly, to a display device having a plurality of optical sensors in a pixel region thereof.

### BACKGROUND ART

In display devices, a method of providing a plurality of optical sensors to achieve an input function such as a touch panel, a pen input, a scanner, or the like has been conventionally known. In order to employ this method for a mobile device that is used in various lighting environments, it is necessary to eliminate effects of the lighting environments. For this reason, a method of removing components that are dependent on a lighting environment from a signal detected by the optical sensors so as to obtain an intrinsic signal to be inputted is also known.

As a conventional configuration that employs such a method, Japanese Patent Application Laid-Open Publication No. 2009-69159 discloses a display imaging device that includes a display imaging panel provided with an image displaying function and an imaging function, and an image processing unit. The image processing unit obtains information regarding at least one of a position, a shape, and a size of an adjacent object through a difference image generating process and a filtering process. The difference image generating process is for generating a difference image between a first image, which is an image of an adjacent object captured by the display imaging panel by utilizing light from this display imaging panel, and a second image, which is an image of a shadow of the adjacent object captured by the display imaging panel. The filtering process is for detecting an adjacent object that is smaller than a prescribed size.

### SUMMARY OF THE INVENTION

The technology disclosed in the above-mentioned Japanese Patent Application Laid-Open Publication No. 2009-69159 is configured to perform a process of extracting fingertips from a difference image and start an event of a next operation, as shown in FIGS. 6, 27, and 28 of the publication.

However, in order to perform the process of extracting fingertips from the difference image, a circuit for performing an image recognition process, a reference database for determining a shape of a recognized image, and the like are needed. That is, the conventional configuration has a problem in that, due to a need for a complex image processing, a device configuration thereof becomes complex.

An object of the present invention is to solve the above-mentioned problem by providing a simplified difference image processing so as to achieve a display device that is capable of determining an event corresponding to an input operation without using a complex circuit configuration for image processing.

In order to achieve the above-mentioned object, a display device disclosed herein that has a plurality of optical sensors in a display region thereof includes: a display panel having a plurality of display pixel circuits and a plurality of sensor pixel circuits; a sensor signal processing circuit for processing outputs from the sensor pixel circuits; a light source disposed on a rear surface of the display panel; a light source control unit for controlling the light source such that one frame period in performing an input through the optical sensors includes an ON period of the light source and an OFF period of the light source; a driver circuit for outputting a first control signal and a second control signal to the sensor pixel circuits and for performing a reset operation and a read-out operation for the sensor pixel circuits, the first control signal indicating a first detection period that includes the ON period of the light source, the second control signal indicating a second detection period that does not include the ON period of the light source; a difference circuit for deriving pixel values that indicate differences between outputs from the sensor pixel circuits, which correspond to charges that have been accumulated in accordance with incident light during the first detection period, and outputs from the sensor pixel circuits, which correspond to charges that have been accumulated in accordance with incident light during the second detection period; a histogram creating unit for extracting a histogram from the pixel values derived by the difference circuit; and an operation determining unit for determining an operation in accordance with the input through the optical sensors on the basis of the histogram.

According to such a configuration, the difference image processing can be simplified, and therefore, it becomes possible to provide a display device that can identify an event corresponding to an input operation without using a complex circuit configuration for the image processing.

### BRIEF DESCRIPTION OF THE DRAWINGS

FIG. 1 is a block diagram that shows a configuration of a display device according to an embodiment of the present invention.

FIG. 2 is a diagram showing an arrangement of sensor pixel circuits in a display panel provided in the display device shown in FIG. 1.

FIG. 3 is a diagram showing ON/OFF timing of a backlight, and reset and read-out timing for the sensor pixel circuits in the display device shown in FIG. 1.

FIG. 4 is a signal waveform diagram of the display panel provided in the display device shown in FIG. 1.

FIG. 5 is a diagram schematically showing a configuration of the sensor pixel circuit in the display device shown in FIG. 1.

FIG. 6 is a circuit diagram of a sensor pixel circuit according to Embodiment 1 of the present invention.

FIG. 7 is a diagram illustrating an operation of the sensor pixel circuit shown in FIG. 6.

FIG. 8 is a signal waveform diagram of the sensor pixel circuit shown in FIG. 6.

FIG. 9 is a block diagram showing a configuration for processing a difference signal that is output from a difference circuit in the display device shown in FIG. 1.

FIG. 10 is a flowchart illustrating an overview of a process in the display device shown in FIG. 1.

FIG. 11 is an example of a histogram.

FIG. 12 is a diagram showing ON/OFF timing of the backlight, and reset and read-out timing for the sensor pixel circuits in the display device shown in FIG. 1.

FIG. 13 is an example of a signal waveform diagram of the display panel provided in the display device shown in FIG. 1.

FIG. 14 is a signal waveform diagram of the sensor pixel circuit that is driven by the signal shown in FIG. 13.

FIG. 15 is another example of a signal waveform diagram of the display panel provided in the display device shown in FIG. 1.

### DETAILED DESCRIPTION OF EMBODIMENTS

A display device according to an embodiment of the present invention has a plurality of optical sensors in a display region thereof, and includes a display panel that has a plurality of display pixel circuits and a plurality of sensor pixel circuits, a sensor signal processing circuit for processing outputs from the sensor pixel circuits, a light source that is disposed on a rear surface of the display panel, a light source control unit for controlling the light source such that one frame period in performing an input through the optical sensors includes an ON period of the light source and an OFF period of the light source, a driver circuit for outputting a first control signal and a second control signal to the sensor pixel circuits and for performing a reset operation and a read-out operation for the sensor pixel circuits, the first control signal indicating a first detection period that includes the ON period of the light source, the second control signal indicating a second detection period that does not include the ON period of the light source, a difference circuit for deriving pixel values indicating differences between outputs from the sensor pixel circuits, which correspond to charges that have been accumulated in accordance with incident light during the first detection period, and outputs from the sensor pixel circuits, which correspond to charges that have been accumulated in accordance with incident light during the second detection period, a histogram creating unit that extracts a histogram from the pixel values derived by the difference circuit, and an operation determining unit for determining an operation in accordance with the input through the optical sensor on the basis of the histogram (first configuration).

In this embodiment, the difference circuit derives pixel values indicating differences between outputs from the sensor pixel circuits, which correspond to charges that have been accumulated in accordance with incident light during the first detection period that includes the ON period of the light source, and outputs from the sensor pixel circuits, which correspond to charges that have been accumulated in accordance with incident light during the second detection period that does not include the ON period of the light source. The histogram creating unit extracts a histogram from the pixel values derived by the difference circuit, and the operation determining unit determines an operation in accordance with the input through the optical sensor based on the extracted histogram. Therefore, in contrast to the conventional configuration that requires a complex image processing, in the configuration according to this embodiment, a next operation can be determined simply by extracting the histogram from the pixel values. This makes it possible to simplify the difference image processing, and as a result, a display device that is capable of identifying an event that corresponds to an input operation without using a complex circuit configuration for image processing can be provided.

In the first configuration, the light source is preferably an infrared light source (second configuration). Because the infrared is not visible to human eyes, it allows an input operation detection to be performed without affecting a display.

In the first configuration or the second configuration, the light source is preferably turned on once during one frame period. The sensor pixel circuits preferably include a first sensor pixel circuit and a second sensor pixel circuit. The first sensor pixel circuit detects light during a detection period during which the light source is on, and holds a detected light amount during other times in accordance with the first control signal. The second sensor pixel circuit detects light during a detection period during which the light source is off, and holds a detected light amount during other times in accordance with the second control signal. The driver circuit preferably performs the read-out operation for the first sensor pixel circuit and the second sensor pixel circuit sequentially line by line in a period other than the detection period during which the light source is on and other than the detection period during which the light source is off (third configuration).

In the first through third configurations, the light source may be turned on for a prescribed length of time once during one frame period. The detection period during which the light source is on and the detection period during which the light source is off may be set so as to occur one time each during one frame period (fourth configuration).

In the fourth configuration, the driver circuit may perform the reset operation for the first sensor pixel circuit at a beginning of the detection period during which the light source is on, and perform the reset operation for the second sensor pixel circuit at a beginning of the detection period during which the light source is off (fifth configuration).

In the fourth configuration, it is preferable that the detection period during which the light source is on and the detection period during which the light source is off be the same in length (sixth configuration).

In the first through sixth configurations, it is preferable that the display panel further include a plurality of output lines that transfer output signals of the first sensor pixel circuit and the second sensor pixel circuit. The first sensor pixel circuit and the second sensor pixel circuit are preferably connected to different output lines, respectively, by type. The driver circuit preferably performs the read-out operation for the first sensor pixel circuit and the second sensor pixel circuit in parallel (seventh configuration).

In the first configuration, it is preferable that the driver circuit respectively perform the reset operation for the sensor pixel circuits and the read-out operation for the sensor pixel circuits in parallel sequentially line by line (eighth configuration).

In the eighth configuration, the driver circuit preferably performs the reset operation for the sensor pixel circuits and the read-out operation from the sensor pixel circuits one time each during one frame period, and it is preferable that the reset operation and the read-out operation are respectively continued for almost one frame period (ninth configuration).

In the ninth configuration, the driver circuit preferably performs the reset operation for the sensor pixel circuits of one row immediately after the read-out operation for the sensor pixel circuits of the same row is finished (tenth configuration).

In the first through tenth configurations, the operation determining unit preferably derives the number of pixels that have a pixel value that is equal to or greater than a prescribed threshold value, and based on the derived number of pixels, determines an operation that corresponds to the input through the optical sensors (eleventh configuration).

### EMBODIMENTS

Below, embodiments of the present invention will be explained in detail with reference to figures.

### Embodiment 1

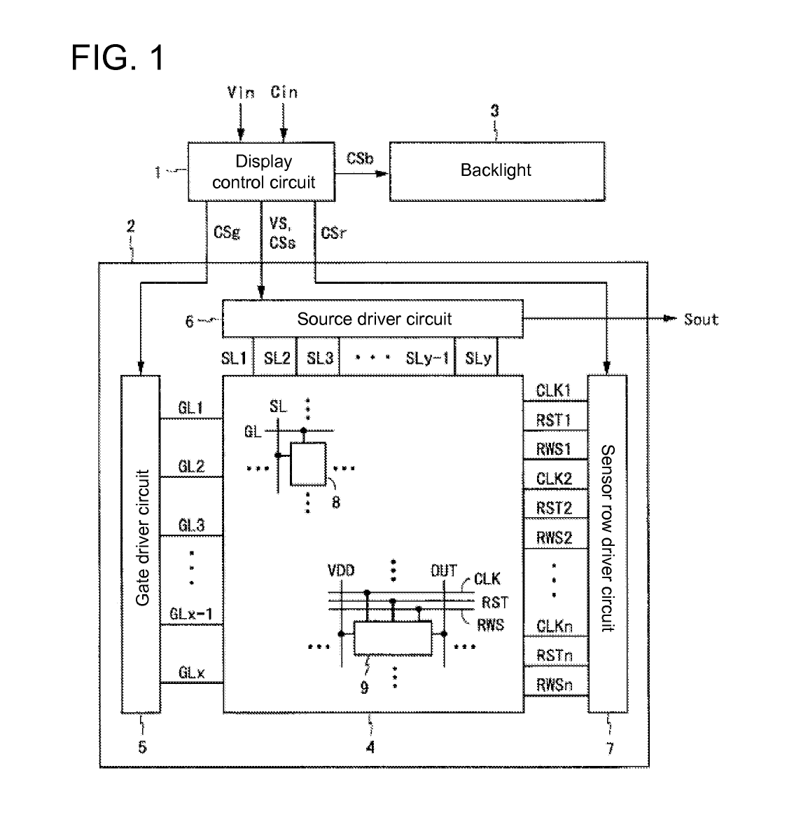

FIG. 1 is a block diagram showing a configuration of a display device according to an embodiment of the present invention. The display device shown in FIG. 1 includes a display control circuit 1, a display panel 2, and a backlight 3. The display panel 2 includes a pixel region 4, a gate driver circuit 5, a source driver circuit 6, and a sensor row driver circuit 7. The pixel region 4 includes a plurality of display pixel circuits 8 and a plurality of sensor pixel circuits 9. This display device has a function of displaying an image on the display panel 2 and a function of detecting light entering the display panel 2. Below, “x” is an integer of 2 or greater, “y” is a multiple of 3, “m” and “n” are even numbers, and a frame rate of the display device is 60 frames per second.

The display device shown in FIG. 1 receives an image signal Vin and a timing control signal Cin from the outside. Based on these signals, the display control circuit 1 outputs an image signal VS and control signals CSg, CSs, and CSr to the display panel 2, and outputs a control signal CSb to the backlight 3. The image signal VS may be the same as the image signal Vin, or may be a signal obtained by performing signal processing to the image signal Vin.

The backlight 3 is a light source that illuminates the display panel 2. More specifically, the backlight 3 is disposed on a rear surface side of the display panel 2, and emits light toward the rear surface of the display panel 2. The backlight 3 is turned on when the control signal CSb is at a high level, and is turned off when the control signal CSb is at a low level. The backlight 3 may be a backlight that is generally used for displaying an image, or may be an infrared backlight that is provided in addition to the backlight used for displaying an image.

In the pixel region 4 of the display panel 2, (xxy) number of display pixel circuits 8 and (nxm/2) number of sensor pixel circuits 9 are respectively arranged in a two-dimensional manner. More specifically, in the pixel region 4, “x” number of gate lines GL1 to GLx and “y” number of source lines SL1 to SLy are provided. The gate lines GL1 to GLx are arranged in parallel with each other. The source lines SL1 to SLy are arranged in parallel with each other so as to cross at a right angle to the gate lines GL1 to GLx. The (xxy) number of display pixel circuits 8 are respectively arranged near the respective intersections of the gate lines GL1 to GLx and the source lines SL1 to SLy. Each display pixel circuit 8 is connected to one gate line GL and one source line SL. There are three different types of the display pixel circuits 8: display pixel circuits for displaying a red color; display pixel circuits for displaying a green color; and display pixel circuits for displaying a blue color. These three types of display pixel circuits 8 are arranged side by side, respectively, in a direction in which the gate lines GL1 to GLx are extended, thereby constituting one color pixel.

In the pixel region 4, “n” number of clock lines CLK1 to CLKn, “n” number of reset lines RST1 to RSTn, and “n” number of read-out lines RWS1 to RWSn are arranged so as to be parallel with the gate lines GL1 to GLx. The pixel region 4 may also have other signal lines or power lines (not shown) arranged so as to be parallel with the gate lines GL1 to GLx. When a read-out operation for the sensor pixel circuits 9 is performed, “m” number of source lines that are selected from the source lines SL1 to SLy are used as power lines VDD1 to VDDm, and other “m” number of source lines are used as output lines OUT1 to OUm.

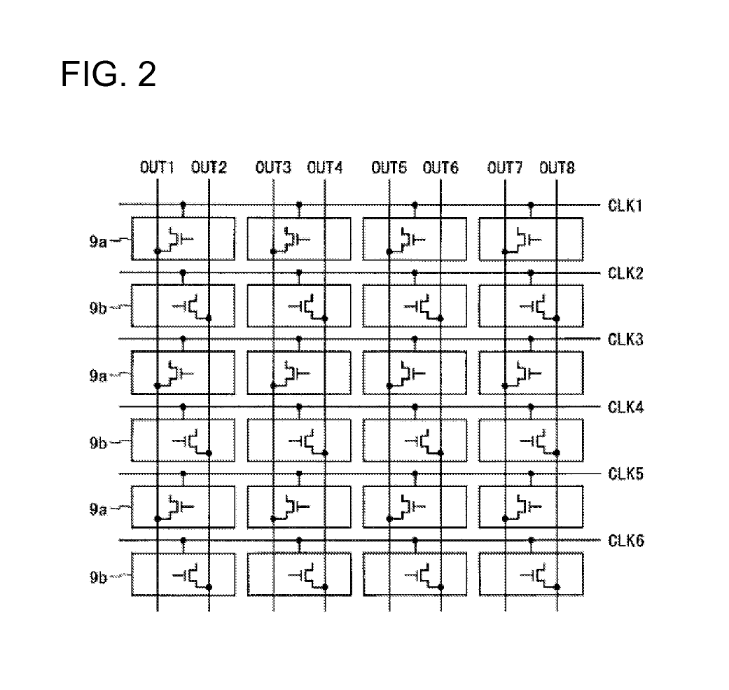

FIG. 2 is a diagram showing an arrangement of the sensor pixel circuits 9 in the pixel region 4. The (nxm/2) number of sensor pixel circuits 9 include first sensor pixel circuits 9a for detecting incident light during an ON period of the backlight 3 and second sensor pixel circuits 9b for detecting incident light during an OFF period of the backlight 3. The number of the first sensor pixel circuits 9a and the number of the second sensor pixel circuits 9b are the same. In FIG. 2, the (nxm/4) number of first sensor pixel circuits 9a are respectively arranged near intersections of the odd-numbered clock lines CLK1 to CLKn−1 and the odd-numbered output lines OUT1 to OUm−1. The (nxm/4) number of second sensor pixel circuits 9b are respectively arranged near intersections of the even-numbered clock lines CLK2 to CLKn and the even-numbered output lines OUT2 to OUm. As described above, the display panel 2 includes the plurality of output lines OUT1 to OUm for transferring output signals of the first sensor pixel circuits 9a and output signals of the second sensor pixel circuits 9b, and the first sensor pixel circuits 9a and the second sensor pixel circuits 9b are respectively connected to different output lines by type.

The gate driver circuit 5 drives the gate lines GL1 to GLx. More specifically, the gate driver circuit 5 sequentially selects one gate line from the gate lines GL1 to GLx based on the control signal CSg, and applies a high-level potential to the selected gate line. The other gate lines are applied with a low-level potential. This way, the “y” number of display pixel circuits 8 that are connected to the selected gate line are collectively selected.

The source driver circuit 6 drives the source lines SL1 to SLy. More specifically, the source driver circuit 6 applies potentials corresponding to the image signal VS to the source lines SL1 to SLy in accordance with the control signal CSs. The source driver circuit 6 may drive respective lines sequentially, or may drive respective pixels sequentially. The potentials applied to the source lines SL1 to SLy are written in the “y” number of display pixel circuits 8 that are selected by the gate driver circuit 5. As described above, by writing potentials corresponding to the image signal VS in all of the display pixel circuits 8 through the gate driver circuit 5 and the source driver circuit 6, a desired image can be displayed on the display panel 2.

The sensor row driver circuit 7 drives the clock lines CLK1 to CLKn, the reset lines RST1 to RSTn, the read-out lines RWS1 to RWSn, and the like. More specifically, the display device according to this embodiment is configured such that each frame period includes one detection period during which the backlight is on and one detection period during which the backlight is off (which will be later described in detail). The sensor row driver circuit 7 applies a high-level potential to the odd-numbered clock lines CLK1 to CLKn−1 during the detection period during which the backlight is on, and applies the high-level potential to the even-numbered clock lines CLK2 to CLKn during the detection period during which the backlight is off. The sensor row driver circuit 7 also applies the high-level potential to the odd-numbered reset lines RST1 to RSTn−1 at the beginning of the detection period during which the backlight is on, and applies the high-level potential to the even-numbered reset lines RST2 to RSTn at the beginning of the detection period during which the backlight is off. This makes it possible to collectively reset the (nxm/4) number of sensor pixel circuits 9 that are connected to the reset line that was applied with the high-level potential.

The sensor row driver circuit 7 also sequentially selects two adjacent read-out lines from the read-out lines RWS1 to RWSn based on the control signal CSr, and applies a read-out high-level potential to the selected read-out lines. The other read-out lines are applied with a low-level potential. This makes it possible to collectively turn “m” number of sensor pixel circuits 9 that are connected to the two selected read-out lines into a read-out ready state. At this time, the source driver circuit 6 applies the high-level potential to the power lines VDD1 to VDDm. This causes signals (referred to as “sensor signal” below) that respectively correspond to amounts of light detected by the respective sensor pixel circuits 9 to be output from the “m” number of sensor pixel circuits 9 that are in the read-out ready state to the output lines OUT1 to OUm.

The source driver circuit 6 includes a difference circuit (not shown in FIG. 1) that derives differences between the output signals of the first sensor pixel circuit 9a and the output signals of the second sensor pixel circuit 9b. The source driver circuit 6 amplifies the light amount difference derived by the difference circuit, and outputs the amplified signal to the outside of the display panel 2 as a sensor output S out. Although the difference circuit is included in the source driver circuit 6 here, the difference circuit may also be provided in an appropriate location outside of the source driver circuit 6. The difference circuit may be mounted on an active matrix substrate 2 with the COG technology, for example, or may be provided outside of the active matrix substrate 2. The difference circuit may be configured to merely derive differences between the output signals of the first sensor pixel circuit 9a and the output signals of the second sensor pixel circuit 9b, or the difference circuit may perform a calibration or smoothing process for the output signals before deriving the difference.

By reading the sensor signals from all of the sensor pixel circuits 9 through the source driver circuit 6 and the sensor row driver circuit 7 in the manner described above, incident light on the display panel 2 can be detected. The display device shown in FIG. 1 performs the following one-time drive so as to detect incident light on the display panel 2.

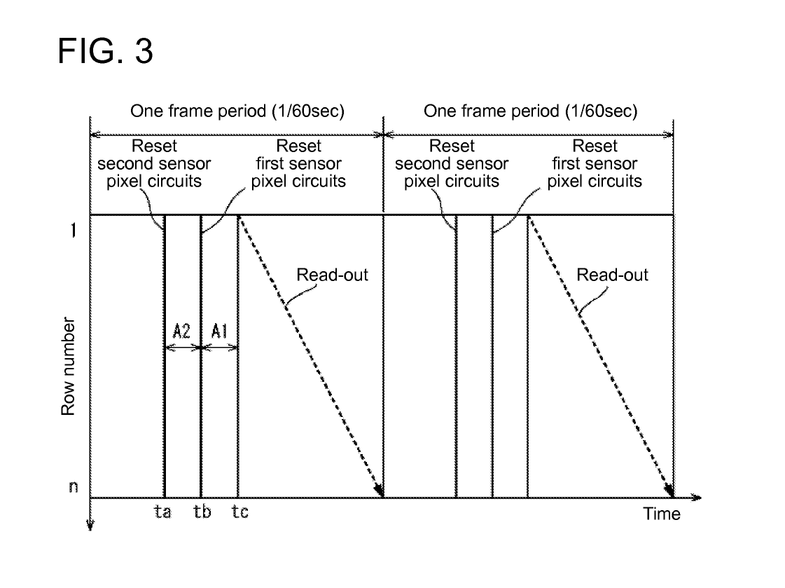

FIG. 3 is a chart showing ON/OFF timing of the backlight 3 and timing for resetting and reading the sensor pixel circuits 9. As shown in FIG. 3, the backlight 3 is turned on once during one frame period for a prescribed length of time, and remains off the rest of the frame period. More specifically, in one frame period, the backlight 3 is turned on at a time tb, and is turned off at a time tc. At the time tb, all of the first sensor pixel circuits 9a are reset, and at the time ta, all of the second sensor pixel circuits 9b are reset.

The first sensor pixel circuits 9a detect incident light during a period A1 (ON period of the backlight 3) between the time tb and the time tc. The second sensor pixel circuits 9b detect incident light during a period A2 (OFF period of the backlight 3) between the time ta and the time tb. The period A1 and the period A2 are the same in length. The read-out operation for the first sensor pixel circuits 9a and the read-out operation for the second sensor pixel circuits 9b are performed sequentially line by line in parallel after the time tc. In FIG. 3, the read-out operation for the sensor pixel circuits 9 completes within one frame period, however, the read-out operation may also be carried over to a subsequent frame period as long as it completes by the time the reset operation for the first sensor pixel circuits 9a is performed in the subsequent frame period.

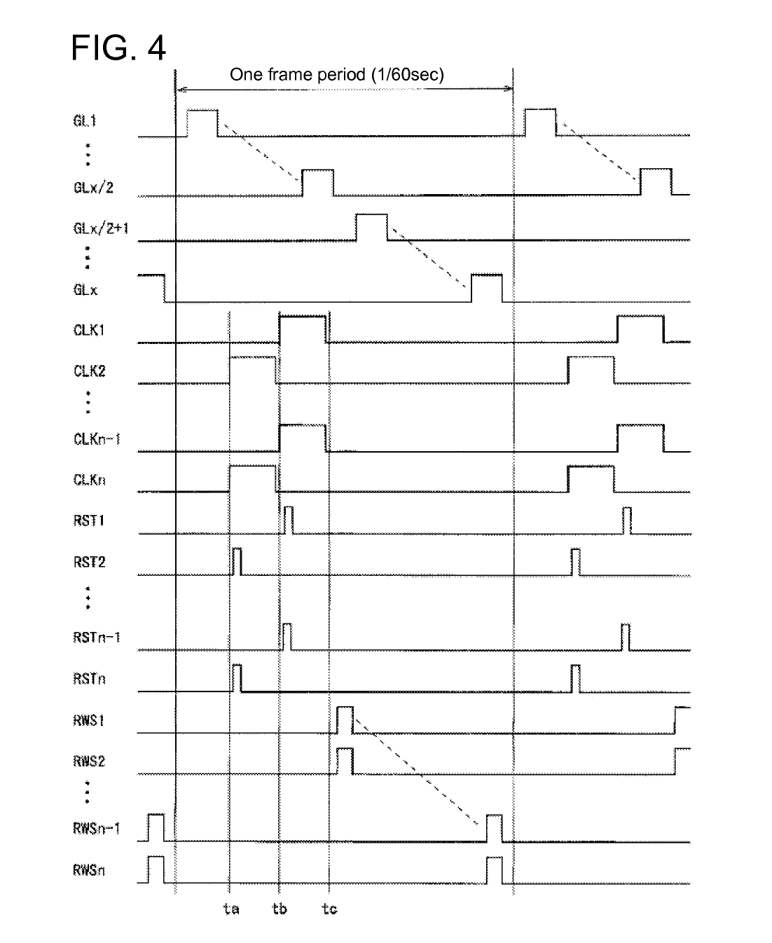

FIG. 4 is a signal waveform diagram of the display panel 2. As shown in FIG. 4, the potential of the gate lines GL1 to GLx is sequentially increased to a high level, one time each during one frame period for a prescribed period of time. The potential of the odd-numbered clock lines CLK1 to CLKn−1 is at a high level throughout the period A1 (more specifically, from the time tb to immediately before the time tc), which occurs once during one frame period. The potential of the even-numbered clock lines CLK2 to CLKn is at the high-level throughout the period A2 (more specifically, from the time to to immediately before the time tb), which occurs once during one frame period. The potential of the odd-numbered reset lines RST1 to RSTn−1 is increased to a high level for a prescribed length of time at the beginning of the period A1, which occurs once during one frame period. The potential of the even-numbered reset lines RST2 to RSTn is increased to the high level for a prescribed length of time at the beginning of the period A2, which occurs once during one frame period. Respective two read-out lines of the read-out lines RWS1 to RWSn are paired with each other, and the potential of the (n/2) pairs of read-out lines is sequentially increased to a high level for a prescribed period of time after the time tc.

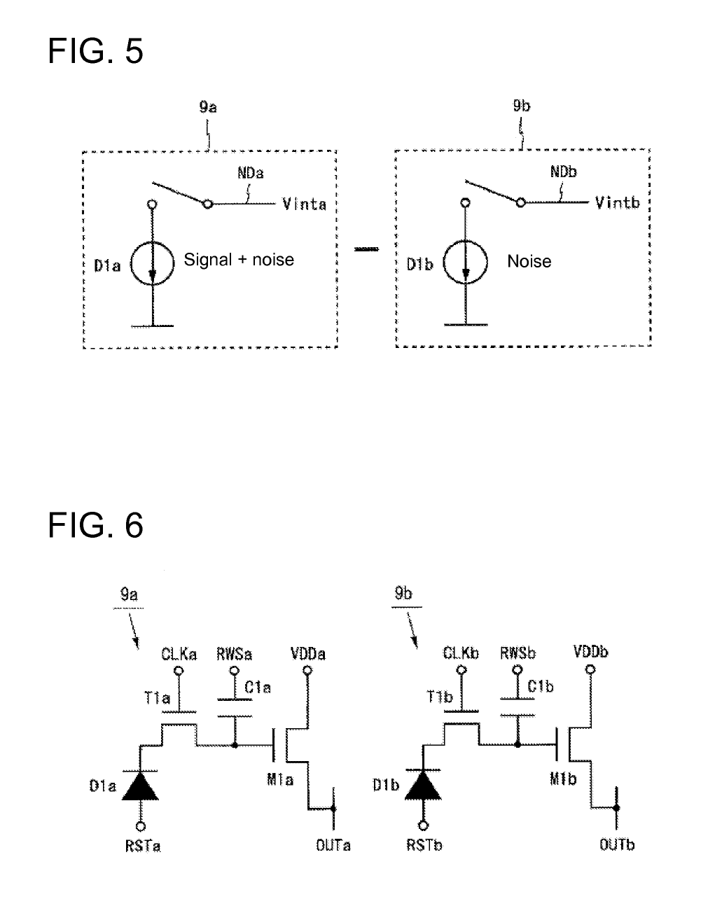

FIG. 5 is a diagram schematically showing configurations of the sensor pixel circuits 9. As shown in FIG. 5, the first sensor pixel circuit 9a includes a photodiode D1a and a storage node NDa. The photodiode D1a extracts from the storage node NDa charges that correspond to an amount of incident light (signal+noise) during the ON period of the backlight 3. The second sensor pixel circuit 9b includes a photodiode D1b and a storage node NDb in a manner similar to the first sensor pixel circuit 9a. The photodiode D1b extracts from the storage node NDb charges that correspond to an amount of incident light (noise) during the OFF period of the backlight 3. The first sensor pixel circuits 9a and the second sensor pixel circuits 9b hold the detected light amount at other times than the prescribed detection periods, respectively. From the first sensor pixel circuit 9a, a sensor signal that corresponds to an amount of incident light during a detection period during which the backlight 3 was on is read out, and from the second sensor pixel circuit 9b, a sensor signal that corresponds to an amount of incident light during a detection period during which the backlight 3 was off is read out. By deriving a difference between the output signal of the first sensor pixel circuit 9a and the output signal of the second sensor pixel circuit 9b through the difference circuit, a difference between an amount of incident light during the ON period of the backlight and an amount of incident light during the OFF period of the backlight can be obtained.

The number of the sensor pixel circuits 9 provided in the pixel region 4 can be appropriately selected. However, it is preferable to connect the first sensor pixel circuit 9a and the second sensor pixel circuit 9b to different output lines, respectively, by type. When (nxm) number of sensor pixel circuits 9 are arranged in the pixel region 4, for example, “n” number of first sensor pixel circuits 9a may be connected to the odd-numbered output lines OUT1 to OUm−1, respectively, and “n” number of second sensor pixel circuits 9b may be connected to the even-numbered output lines OUT2 to OUm, respectively. In this case, the read-out operation for the sensor pixel circuits 9 is performed for one row at a time. Alternatively, the pixel region 4 may be provided with as many (that is, (xxy/3)) sensor pixel circuits 9 as the color pixels. Alternatively, the pixel region 4 may be provided with a fewer number of sensor pixel circuits 9 than that of the color pixels (in a ratio of one sensor pixel circuit to several to tens of color pixels, for example).

As described above, the display device according to the embodiment of the present invention has a plurality of photodiodes (optical sensors) in the display region 4, and includes the display panel 2 that has the plurality of display pixel circuits 8 and the plurality of sensor pixel circuits 9, the backlight 3 that is turned on for a prescribed length of time once during one frame period, and the sensor row driver circuit 7 (driver circuit) that outputs to the sensor pixel circuits 9 the odd-numbered clock signals CLK1 to CLKn−1 (first control signal) for indicating the detection period during which the backlight is on and the even-numbered clock signals CLK2 to CLKn (second control signal) for indicating the detection period during which the backlight is off. The sensor row driver circuit 7 also performs a reset operation and a read-out operation for the sensor pixel circuits 9. The sensor pixel circuits 9 include the first sensor pixel circuits 9a and the second sensor pixel circuits 9b. The first sensor pixel circuits 9a detect light during the detection period during which the backlight is on, and hold the detected light amounts for the rest of the time in accordance with the odd-numbered clock signals CLK1 to CLKn−1. The second sensor pixel circuits 9b detect light during the detection period during which the backlight is off, and hold the detected light amounts for the rest of the time in accordance with the even-numbered clock signals CLK2 to CLKn. The sensor row driver circuit 7 performs the read-out operation for the first sensor pixel circuits 9a and the read-out operation for the second sensor pixel circuits 9b sequentially line by line during a period other than the detection period during which the backlight is on and the detection period during which the backlight is off.

Therefore, according to the display device of this embodiment, an amount of incident light during an ON period of the backlight and an amount of incident light during an OFF period of the backlight can be separately detected by using two types of sensor pixel circuits, and differences between the amounts of the two types of light can be derived outside of the sensor pixel circuits. This makes it possible to achieve an input function that is not affected by a lighting environment. As compared with a case where amounts of the two types of light are detected by a single sensor pixel circuit, the frequency of the read-out operation for the sensor pixel circuit can be reduced, and the read-out speed can be lowered, thereby achieving the lower power consumption in the device. Also, because the read-out operation for the sensor pixel circuits is performed during a period other than the detection periods, the ON/OFF timing of the backlight, and timing for resetting and reading the sensor pixel circuits can be determined more freely.

The sensor row driver circuit 7 resets the first sensor pixel circuits 9a at the beginning of the detection period during which the backlight is on, and resets the second sensor pixel circuits 9b at the beginning of the detection period during which the backlight is off. By resetting the sensor pixel circuits at the beginning of the respective detection periods as described above, the amount of light in each sensor pixel circuit can be detected more accurately. Because the sensor pixel circuits of the same type are collectively reset at once, it becomes possible for the sensor pixel circuits of the same type to detect light during the same period. Also, the time required for resetting can be shorter, which allows more freedom in determining the read-out timing.

The detection period during which the backlight is on (A1 in FIG. 3) starts immediately after the detection period during which the backlight is off (A2 in FIG. 3). By having two types of detection periods close to each other as described, a gap between the two types of detection periods can be eliminated, thereby preventing the responsiveness to a motion input from being affected by an input direction. Because the detection period during which the backlight is on starts immediately after the detection period during which the backlight is off, even when the display device is provided with a backlight that takes a longer time to light up than to go off, it becomes possible to ensure the backlight 3 is on throughout the entire detection period during which the backlight is on, and as a result, the detection accuracy can be increased. Also, because the two types of detection periods are the same in length, an amount of incident light during the ON period of the backlight and an amount of incident light during the OFF period of the backlight are detected for the same length of time. This makes it possible to accurately derive a difference between the amount of incident light during the ON period of the backlight and the amount of incident light during the OFF period of the backlight.

The display panel 2 further includes the plurality of output lines OUT1 to OUm for transferring output signals of the first and second sensor pixel circuits 9a and 9b, and the first sensor pixel circuits 9a and the second sensor pixel circuits 9b are respectively connected to different output lines by type. The sensor row driver circuit 7 performs the read-out operation for the first sensor pixel circuits 9a and the read-out operation for the second sensor pixel circuits 9b in parallel. The display panel 2 also includes a difference circuit that derives differences between output signals of the first sensor pixel circuits 9a and output signals of the second sensor pixel circuits 9b. As described above, by respectively connecting the first and second sensor pixel circuits 9a and 9b to different output lines by type, and by performing the read-out operation for the two types of sensor pixel circuits in parallel, the read-out speed can be lowered, thereby reducing the power consumption of the device. Also, by employing the difference circuit, differences between amounts of incident light during the ON period of the backlight and amounts of incident light during the OFF period of the backlight can be immediately derived, which eliminates a need to provide a memory for storing light amounts that has been previously detected.

Below, the sensor pixel circuits 9 included in the display device according to this embodiment will be described in detail. In the description below, each signal line and a signal on the corresponding signal line are given the same reference characters for distinction (a signal on a clock line CLKa is referred to as a clock signal CLKa, for example). The respective first sensor pixel circuits 9a are connected to clock lines CLKa, reset lines RSTa, read-out lines RWSa, power lines VDDa, and output lines OUTa. The respective second sensor pixel circuits 9b are connected to clock lines CLKb, reset lines RSTb, read-out lines RWSb, power lines VDDb, and output lines OUTb. The second sensor pixel circuits 9b have the same configuration as that of the first sensor pixel circuits 9a, and operate in a manner similar to the first sensor pixel circuits 9a, and therefore, the explanation of the second sensor pixel circuit 9b will be appropriately omitted below.

FIG. 6 shows circuit diagrams of the sensor pixel circuits 9. As shown in FIG. 6, each first sensor pixel circuit 9a includes transistors T1a and M1a, the photodiode D1a, and a capacitor C1a. Each second sensor pixel circuit 9b includes transistors T1b and M1b, the photodiode D1b, and a capacitor C1b. The transistors T1a, M1a, T1b, and M1b are N-type TFTs (Thin Film Transistors).

In each of the first sensor pixel circuit 9a, the anode of the photodiode D1a is connected to the reset line RSTa, and the cathode is connected to the source of the transistor T1a. The gate of the transistor T1a is connected to the clock line CLKa, and the drain is connected to the gate of the transistor M1a. The drain of the transistor M1a is connected to the power line VDDa, and the source is connected to the output line OUTa. The capacitor C1a is disposed between the gate of the transistor M1a and the read-out line RWSa. In the first sensor pixel circuit 9a, a node that is connected to the gate of the transistor M1a becomes a storage node that accumulates charges in accordance with a detected light amount, and the transistor M1a functions as a read-out transistor. The second sensor pixel circuit 9b has the same configuration as that of the first sensor pixel circuit 9a.

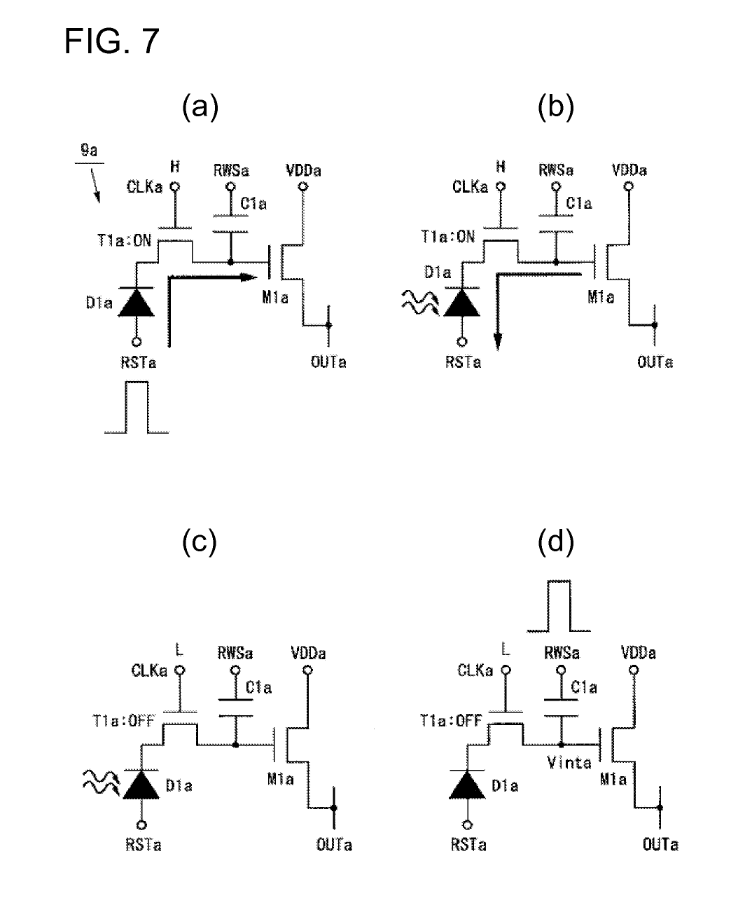

FIG. 7 shows diagrams that illustrate an operation of the first sensor pixel circuits 9a. As shown in FIG. 7, the first sensor pixel circuits 9a perform the following operations during one frame period: (a) resetting; (b) accumulating; (c) holding; and (d) reading.

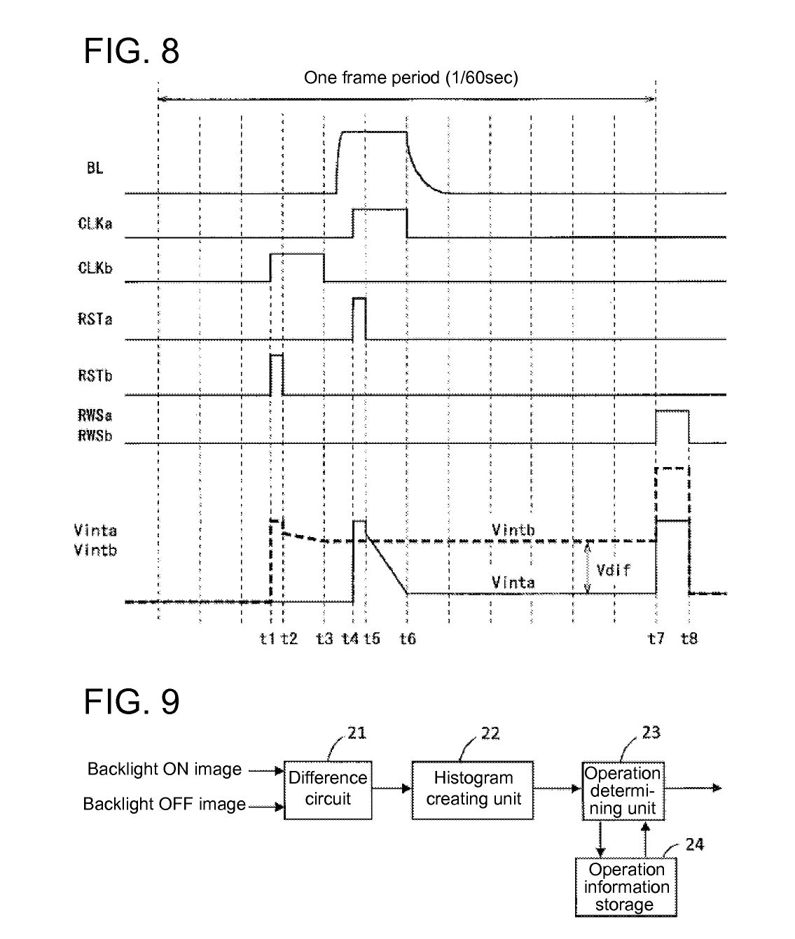

FIG. 8 is a signal waveform diagram of the first sensor pixel circuits 9a and the second sensor pixel circuits 9b. In FIG. 8, BL indicates the brightness of the backlight 3, Vinta indicates a potential of the storage nodes (gate potential of the transistors M1a) of the first sensor pixel circuits 9a, and Vintb indicates a potential of the storage nodes (gate potential of the transistors M1b) of the second sensor pixel circuits 9b. In the first sensor pixel circuits 9a, a period from a time t4 through a time t5 is a reset period, a period from the time t5 though a time t6 is an accumulating period, a period from the time t6 through a time t7 is a holding period, and a period from the time t7 through a time t8 is a read-out period. In the second sensor pixel circuits 9b, a period from a time t1 through a time t2 is a reset period, a period from the time t2 though a time t3 is an accumulating period, a period from the time t3 through the time t7 is a holding period, and a period from the time t7 through the time t8 is a read-out period.

In the reset period of the first sensor pixel circuits 9a, the clock signal CLKa is set to a high level, the read-out signal RWSa is set to a low level, and the reset signal RSTa is set to a high level for resetting. This turns on the transistors T1a, which causes a current (forward-bias current of the photodiode D1a) to flow from the reset lines RSTa to the storage nodes through the photodiodes D1a and the transistors T1a (FIG. 7(a)), and as a result, the potential Vinta is reset to a prescribed level.

In the accumulating period of the first sensor pixel circuits 9a, the clock signal CLKa is set to the high level, the reset signal RSTa and the read-out signal RWSa are set to the low level. This turns on the transistors T1a. If the photodiodes D1a receive light during this period, a current (photocurrent of the photodiodes D1a) flows from the storage nodes to the reset lines RSTa through the transistors T1a and the photodiodes D1a, which causes the charges to be extracted from the storage nodes (FIG. 7(b)). As a result, the potential Vinta is lowered in accordance with the amount of light that entered while the clock signal CLKa is at the high level (ON period of the backlight 3).

In the holding period of the first sensor pixel circuits 9a, the clock signal CLKa, the reset signal RSTa, and the read-out signal RWSa are set to the low level. This turns off the transistors T1a. Even if the photodiodes D1a receive light during this period, because the transistors T1a are off, and the photodiodes D1a and the gates of the transistors M1a are therefore electrically disconnected, the potential Vinta is not changed (FIG. 7(c)).

In the read-out period of the first sensor pixel circuits 9a, the clock signal CLKa and the reset signal RSTa are set to the low level, and the read-out signal RWSa is set to the high-level for reading. The transistors T1a remain off during this period. Also, here, the potential Vinta is increased by an amount corresponding to (Cqa/Cpa) times of the size of the potential increase in the read-out signal RWSa (Cpa is a total capacitance value of the first sensor pixel circuits 9a, and Cqa is a capacitance value of the capacitors C1a). The transistors M1a construct source follower amplifier circuits by using transistors (not shown) included in the source driver circuit 6 as a load, and drive the output lines OUTa in accordance with the potential Vinta (FIG. 7(d)).

The second sensor pixel circuits 9b are operated in a manner similar to the first sensor pixel circuits 9a. The potential Vintb is reset to a prescribed level in the reset period, and is lowered during the accumulating period in accordance with an amount of light that entered while the clock signal CLKb is at the high level (OFF period of the backlight 3). The potential Vintb is not changed during the holding period. In the read-out period, the potential Vintb is increased by an amount corresponding to (Cqb/Cpb) times of the size of increase in the potential of the read-out signal RWSb (Cpb is a total capacitance value of the second sensor pixel circuits 9b, and Cqb is a capacitance value of the capacitors C1b), and the transistors M1b drive the output lines OUTb in accordance with the potential Vintb.

As described above, each of the first sensor pixel circuits 9a according to this embodiment includes one photodiode D1a (optical sensor), one storage node for accumulating charges in accordance with the detected light amount, the transistor M1a (read-out transistor) having the control terminal thereof connected to the storage node, and the transistor T1a (switching element for holding) that is provided on a path of a current flowing through the photodiode D1a and that is turned on and off in accordance with the clock signal CLK. The transistor T1a is disposed between the storage node and one end of the photodiode D1a. The other end of the photodiode D1a is connected to the reset line RSTa. The transistor T1a is turned on in accordance with the clock signal CLKa during the detection period during which the backlight is on. The second sensor pixel circuits 9b have a configuration similar to that of the first sensor pixel circuits 9a, and the transistors T1b in the second sensor pixel circuits 9b are turned on during the detection period during which the backlight is off.

In the manner described above, the transistors T1a that are turned on during the detection period during which the backlight is on are provided on the path of the current flowing through the photodiodes D1a, and the transistors T1b that are turned on during the detection period during which the backlight is off are provided on the path of the current flowing through the photodiodes D1b. This way, the first sensor pixel circuits 9a that detect light during the detection period during which the backlight is on and that hold the detected light amount for the rest of the time, and the second sensor pixel circuits 9b that detect light during the detection period during which the backlight is off and that hold the detected light amount for the rest of the time can be achieved.

Next, the processing of the difference signal derived by the difference circuit will be explained.

FIG. 9 is a block diagram showing a configuration for processing the difference signal output from the difference circuit in the display panel 2 according to this embodiment. As shown in FIG. 9, the display panel 2 according to this embodiment includes a difference circuit 21, a histogram creating unit 22, an operation determining unit 23, and an operation information storage 24.

As described above, the difference circuit 21 derives differences between the sensor outputs that correspond to amounts of light detected during the detection period during which the backlight is on (A1) and the sensor outputs that correspond to amounts of light detected during the detection period during which the backlight is off (A2). That is, as shown in FIG. 2, when the display panel 2 is provided with the (nxm/4) number of first sensor pixel circuits 9a and the (nxm/4) number of second sensor pixel circuits 9b, the difference circuit 21 derives differences between sensor outputs of respective two pixel circuits that are adjacent to each other in the “y” direction (a direction in which the source ahead is extended) among the (m/2) number of first sensor pixel circuits 9a that are connected to the clock lines CLK(k) and the (m/2) number of second sensor pixel circuits 9b that are connected to the clock lines CLK(k+1). In FIG. 2, for example, a difference between the sensor output of the first sensor pixel circuit 9a that is connected to the clock line CLK1 and the output line OUT1 and the sensor output of the second sensor pixel circuit 9b that is connected to the clock line CLK2 and the output line OUT2 is derived. Therefore, a difference value derived here is a value of each pixel (pixel value) in an array of pixels that are arranged on the display panel 2 with (m/2) columns in the “x” direction and (n/2) rows in the “y” direction. That is, the difference value (pixel value) is a value indicating the brightness of each of these pixels.

The histogram creating unit 22 extracts a histogram from the pixel values derived by the difference circuit 21. The operation determining unit 23 determines an operation (event) that is to be executed next based on the histogram extracted by the histogram creating unit 22 and prescribed threshold values. The prescribed threshold values and commands provided for starting an event that is to be executed next are stored in the operation information storage 24.

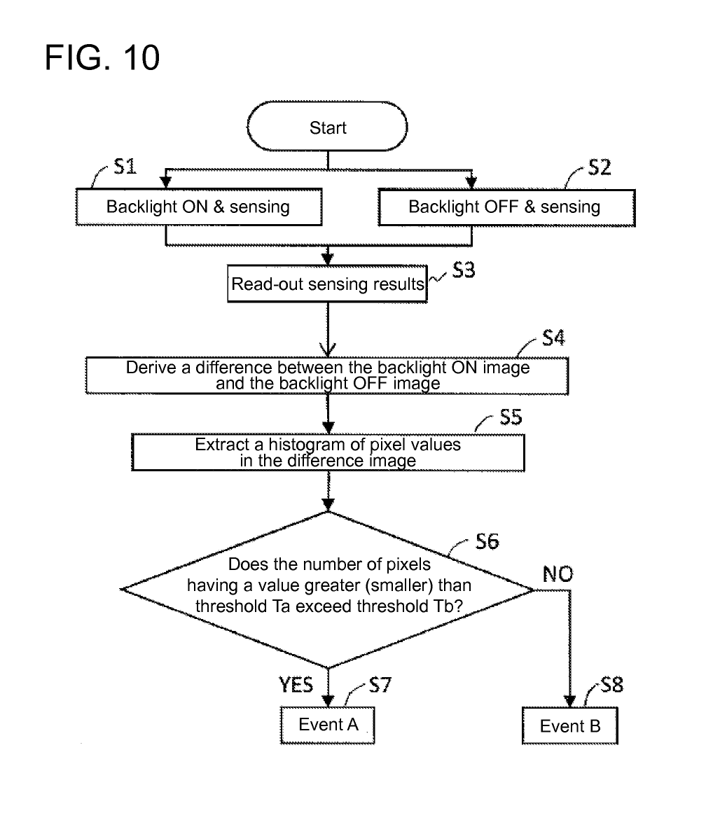

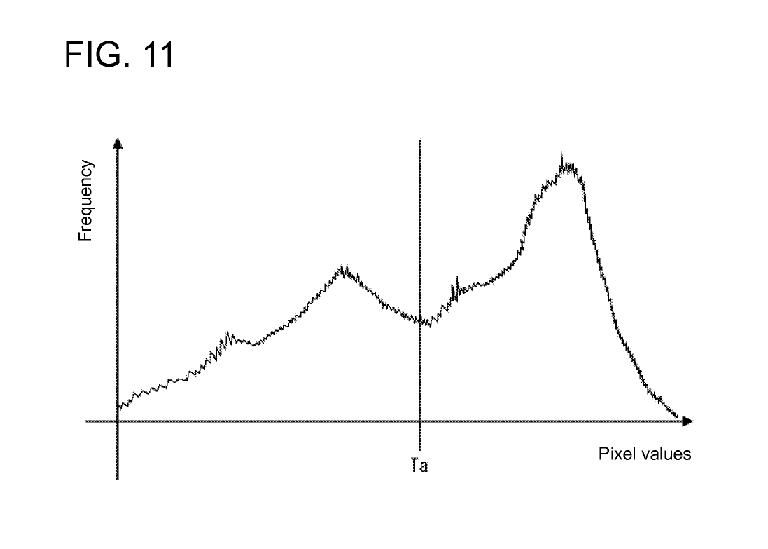

FIG. 10 is a flowchart that shows an overview of the process in the display panel 2. A step S1 shown in FIG. 10 is performed during the detection period A1 shown in FIG. 3. A step S2 is performed during the detection period A2 shown in FIG. 3. A step S3 is performed during the read-out period shown in FIG. 3. In a step S4, as described above, the difference circuit 21 derives respective differences (pixel values) between the sensor outputs of the first sensor pixel circuits 9a and the sensor outputs of the second sensor pixel circuits 9b. Next, in a step S5, the histogram creating unit 22 extracts a histogram from the pixel values obtained in the step S4. Thereafter, in a step S6, the operation determining unit 23 refers to the histogram extracted in the step S5, and judges whether or not the number of pixels having a pixel value that is greater (or smaller) than a prescribed threshold Ta exceeds a prescribed threshold Tb. Based on the judgment result in the step S6, the operation determining unit 23 determines an event that is to be executed next. That is, the operation determining unit 23 obtains a total number of pixels having a pixel value that is greater (or smaller) than the threshold Ta in a histogram shown in FIG. 11, for example, and compares the obtained total number with the threshold Tb. The values of the thresholds Ta and Tb can be suitably selected for purposes and the like. However, setting the value of the threshold Ta to 50% or less of the maximum detectable pixel value is advantageous in that it allows for a proper operation even when an object that has relatively low reflectance is to be detected. Alternatively, setting the value of the threshold Ta to 50% or more of the maximum detectable pixel value is advantageous in that an erroneous operation caused by an approach of an unexpected object can be prevented.

Below, more specific examples of the process of the steps S6 to S8 will be described, however, embodiments of the present invention are not limited to examples described herein. Values of thresholds used in the following examples are illustrative only, for example.

### Example 1

When the display panel 2 is a liquid crystal panel of four-inch WVGA (800×480 pixels), for example, pixel values of 400×240 pixels can be obtained as outputs from the difference circuit 21. In this case, if a human finger approaches a surface of the display panel 2, about 20 to 25 pixels show values of 10 to 20 as gradation levels. Here, a value of the threshold to Ta is set to 10 (gradation level), and a value of the threshold Tb is set to 12000 (pixels). When it is determined that the number of pixels having a pixel value that is greater than the threshold Ta exceeded the threshold Tb in the step S6, an event of discontinuing display and sensing operations of the display panel 2 is performed as an “event A” in a step S7. In a step S8, the current operation is continuously performed as an “event B.”

This example can be effectively used when the display panel 2 of this embodiment is provided in a mobile phone terminal or a portable digital assistant having a telephone function, for example. That is, when a user places his ear (face) near the display panel 2 upon receiving an incoming call, pixel values of almost all of the pixels in the display panel 2 become 10 or greater. Therefore, with this example, when the device receives an incoming call, the display and sensing operations in the display panel 2 are discontinued. This allows for a reduction in the power consumption and for a prevention of an erroneous operation caused by an ear or the like touching the display panel 2.

### Example 2

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 12000 (pixels). In this example, the display panel 2 is provided in a mobile phone terminal or a portable digital assistant having a telephone function.

When it is determined that the number of pixels having a pixel value that is greater than the threshold Ta exceeded the threshold Tb in the step S6, an “answering” operation is performed as the “event A” in the step S7. In the step S8, the current operation is continuously performed as the “event B.”

According to this example, when a user places his ear (face) near the display panel 2 upon receiving an incoming call, pixel values of almost all of the pixels in the display panel 2 become 10 or greater. Therefore, with this example, when the device receives an incoming call, and when the user places his ear near the display panel 2, the “answering” event is automatically executed. This way, a device that does not require a user to perform the “answering” operation can be provided.

### Example 3

In this example, similar to Example 1, the display panel 2 is a liquid crystal panel of four-inch WVGA (800×480 pixels), and pixel values of 400×240 pixels can be obtained as outputs from the difference circuit 21. This example requires, in addition to the histogram, a finger recognition circuit for positions and the number (n) of fingers that are swinging the display panel 2 based on the pixel values. In this case, the value of the threshold Ta is set to 10 (gradation level), and the value of the threshold Tb is set to 25n (pixels).

When touches of the “n” number of fingers are detected by the finger recognition circuit, and when it is determined that the number of pixels having a pixel value that is greater than the threshold Ta exceeded the threshold Tb in the step S6, a “shift-key operation in JIS keyboard” is performed as the “event A” in the step S7. In the step S8, the current operation is continuously performed as the “event B.”

According to this example, it becomes possible to configure the display device such that when the user is touching the panel only with fingertips, these touches are recognized as normal input operations, but when the user performs an input operation by placing a finger flat or performs an input operation while covering a portion of the display panel 2 with a palm, another finger, or the like, it is determined that the user is performing the shift-key operation. This way, a device allowing for simplified input operations can be provided.

### Example 4

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 12000 (pixels).

When it is determined that the number of pixels having a pixel value that is greater than the threshold Ta exceeded the threshold Tb in the step S6, a “power-off” operation is performed as the “event A” in the step S7. In the step S8, the current operation is continuously performed as the “event B.”

According to this example, the device can be turned off simply by covering the display panel 2 with a hand, or by placing the device on the desk with the side of the display panel 2 facing down.

### Example 5

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 12000 (pixels). In this example, the display device according to this embodiment is a mobile phone terminal or a portable digital assistant having a telephone function.

When it is determined that the number of pixels having a pixel value that is greater than the threshold Ta exceeded the threshold Tb in the step S6, a “silent mode on” operation is performed as the “event A” in the step S7. In the step S8, the current operation is continuously performed as the “event B.”

According to this example, the silent mode of the device can be turned on simply by covering the display panel 2 with a hand, or by placing the device on the desk with the side of the display panel 2 facing down.

### Example 6

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 12000 (pixels). In this example, the display device is equipped with an image memory for storing display images corresponding to two screens of the display panel 2.

When it is determined that the number of pixels having a pixel value that is greater than the threshold Ta exceeded the threshold Tb in the step S6, a “display image switching” operation is performed as the “event A” in the step S7. In the step S8, the current operation is continuously performed as the “event B.”

According to this example, simply by covering the display panel 2 with a hand, or by placing the device on the desk with the side of the display panel 2 facing down, an operation to read another image out from the image memory and display that image on the screen of the display panel 2, which is an operation to switch display images from one to another, can be performed.

This Example 6 can be used for switching display contents between a main screen and a sub screen in a computer that has both the main screen and the sub screen. This example can also be used for switching display contents from one to another in a multi-view display that has a plurality of display screens, for example.

### Example 7

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 12000 (pixels). In this example, a program for editing a text displayed on the display panel 2 is running.

When it is determined that the number of pixels having a pixel value that is greater than the threshold Ta exceeded the threshold Tb in the step S6, an event of applying the immediately preceding input operation to the entire text is performed as the “event A” in the step S7. This makes it possible to send an instruction to the text editing program to “select” the entire text by covering the display panel 2 with a palm or the like after selecting the “select” command, for example. This also makes it possible to instruct the text editing program to “delete” the entire text by covering the display panel 2 with a palm or the like after selecting the “delete” command, for example. This way, a device allowing for simple user input operations can be provided.

### Example 8

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 25 (pixels). In this example, the display device of this embodiment is a portable digital assistant that also functions as a music player.

When it is determined that the number of pixels having a pixel value that is greater than the threshold Ta exceeded the threshold Tb in the step S6, an instruction to turn the volume up is sent to the music player as the “event A” in the step S7. The “event B” in the step S8 is an operation to maintain the current volume. This way, when the display panel is touched by a single finger, the current volume is maintained, and when being touched with a plurality of fingers or an entire palm, the volume is increased, for example. In this example, it is also preferable to adjust a degree of volume increase in accordance with the number of pixels beyond the threshold Tb. That is, by configuring the device such that the volume is increased more as a touch area becomes larger, an input operation that allows for an intuitive control by a user can be achieved.

### Example 9

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 25 (pixels).

When it is determined that the number of pixels having a pixel value that is greater than the threshold Ta exceeded the threshold Tb in the step S6, an operation of enlarging an image on the display panel 2 is performed in the step S7 as the “event A.” As the “event B” in the step S8, an operation to display an entire image is performed.

This way, when the display panel is touched by a single finger, the entire image is displayed with a small enlargement ratio, and when being touched by a plurality of fingers or an entire palm, an enlarged image is displayed, for example. In this example, it is preferable to adjust the enlargement factor in accordance with the number of pixels beyond the threshold Tb. That is, by configuring the device such that the enlargement factor become greater as a touch area becomes larger, an input operation that allows for an intuitive control by a user can be achieved.

### Example 10

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and the value of the threshold Tb is set to 25 (pixels). In this example, the display device of this embodiment is a portable device with a TV tuner that functions as a TV receiver.

When it is determined that the number of pixels having a pixel value that is greater than the threshold Ta exceeded the threshold Tb in the step S6, an instruction to change and select channels in ascending order is sent to the TV tuner in the step S7 as the “event A.” As the “event B” in the step S8, an instruction to change and select channels in descending order is sent to the TV tuner.

This way, when the display panel is touched by a single finger, the channel is changed in descending order, and when being touched by a plurality of fingers or an entire palm, the channel is changed in ascending order, for example.

As a modification example of this example, the channel may be directly changed from one to another in accordance with the number of pixels beyond the threshold Tb. That is, by configuring the device such that a particular channel is selected in accordance with a size of a touch area, an input operation that allows for an intuitive control by a user can be achieved.

### Example 11

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level), and a plurality of values that change by a certain increment such as p, 2p, 3p, 4p, . . . (pixels) are provided as the threshold Tb, where “p” is the number of pixels having a pixel value that is greater than the threshold Ta when a single finger is placed near the screen of the display panel 2. In this example, a plurality of windows can be displayed on the screen of the display panel 2 by an OS that is capable of multi-screen or multi-task.

In this example, the number of pixels having a pixel value greater than the value of the threshold Ta is compared with the plurality of levels of the thresholds Tb, and based on the result, the active screen is switched from one to another.

In a case where first through fourth screens are open as the multi-screen, for example, that is, when the number of pixels having a pixel value that is greater than the value of the threshold Ta does not exceed “p,” only the first screen is displayed on the display panel 2. When the number of pixels having a pixel value that is greater than the value of the threshold Ta is between “p” and 2p, the operation determining unit 23 sends to the OS an instruction to change the active screen to the second screen. When the number of pixels having a pixel value that is greater than the value of the threshold Ta is between 2p and 3p, the operation determining unit 23 sends the OS an instruction to change the active screen to the third screen.

This operation allows a user to change the active screen by changing the number of fingers touching the display panel 2. In order to prevent an erroneous operation, it is preferable to set the threshold Tb to 2p or greater.

### Example 12

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level). In this example, the display device of this embodiment is a mobile phone terminal or a portable digital assistant having a telephone function.

In this example, in the step S6, instead of making a binary decision, a number to call is selected in accordance with the number of fingers touching or an area of a touch position. That is, if the number of pixels having a pixel value of 10 or greater is 25 to 49, it is determined that one finger is touching. If the number of the pixels is 50 to 74, two fingers are touching, and if the number of pixels is 75 to 99, three fingers are touching. If the touch is made by one finger, for example, an instruction to call a phone number that has been stored in advance as a speed dial 1 is sent.

With this example, a device allows for simplified input operations can be provided.

### Example 13

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level).

In this example, the step S6 is performed a plurality of times. Different values of the threshold Tb that are unique to the respective times of the step S6 are to be set in advance. Here, the step S6 is performed four times, for example. The values of the threshold Tb for the step S6 of the first time and the third time are set to 25, and the values of the threshold Tb for the step S6 of the second time and the fourth time are set to 12000. It is apparent that more complex combinations may be used as values of the threshold Tb.

When a user touches the display panel 2 with one finger in the first time and the third time, and touches the display panel 2 with the entire palm in the second time and the fourth time, it is determined that the user passed the test in the step S6 four times, thereby turning off a system lock. That is, with this example, a device that allows a user to turn off a system lock by performing an input gesture on the display panel 2 can be provided.

### Example 14

In this example, similar to Example 1, the display panel 2 is a liquid crystal panel of four-inch WVGA (800×480 pixels), and pixel values of 400×240 pixels can be obtained as outputs from the difference circuit 21, the value of the threshold Ta is set to 10 (gradation level). The value of the threshold Tb is set to 12000 (pixels). In this example, the display device of this embodiment is equipped with a photo processing program for organizing photos and performing image processing, and a single photo image is displayed on the display panel 2.

When it is determined that the number of pixels having a pixel value that is greater than the threshold Ta exceeded the threshold Tb in the step S6, an instruction to change a display mode to a mode where a plurality of photo images are displayed as thumbnails is sent to the photo processing program as the “event A” in the step S7. As the “event B” in the step S8, an instruction to maintain the current display is sent.

Examples of the process after the step S6 have been described above, however, embodiments of the present invention are not limited to such examples. That is, the values of the thresholds in the step 6 and events performed in the step S7 and in the step S8 as a result of the judgment in the step S6 may vary depending on a process that is performed immediately before the step S6, and they may be designed appropriately. In the flowchart in FIG. 10 and the respective examples above, the binary decision was made in the step S6. However, by providing different levels of threshold values or by combining a plurality of types of conditions in a complex manner, various controls can further be achieved.

### Embodiment 2

Another embodiment of the present invention will be explained below. Configurations and operations of the difference circuit 21, the histogram creating unit 22, the operation determining unit 23, and the operation information storage 24 of Embodiment 2 are the same as those of Embodiment 1. Embodiment 2 differs from Embodiment 1 in a scheme for detecting sensor signals of the backlight ON period and the backlight OFF period. Explanations of the same portions as those of Embodiment 1 are omitted.

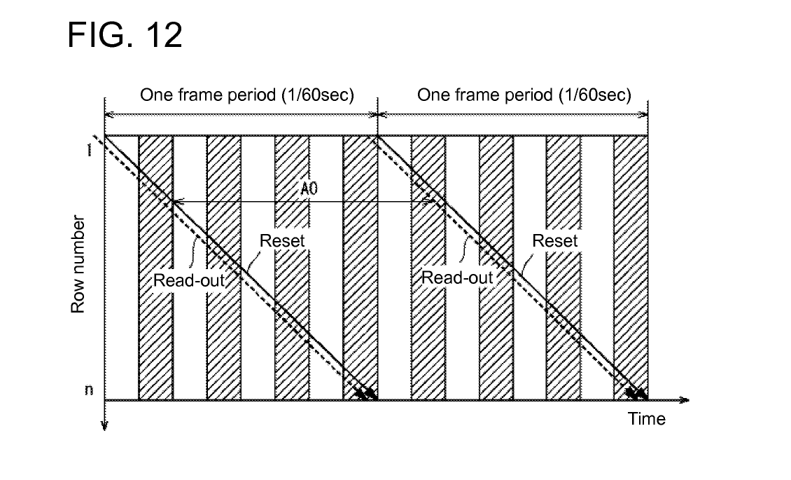

FIG. 12 is a diagram showing ON/OFF timing of the backlight 3 and timing for resetting and reading the sensor pixel circuits 9. As shown in FIG. 12, in Embodiment 2, the backlight 3 is turned on a plurality of times, and is turned off a plurality of times during one frame period. In the following description, the backlight 3 is turned on and off four times each during one frame period. The ON period and the OFF period are the same in length. The reset operation for the sensor pixel circuits 9 is performed line by line sequentially over the course of one frame period (solid arrow). The read-out operation for the sensor pixel circuits 9 is performed after almost one frame period has passed since the reset operation (more specifically, after a period of time that is slightly shorter than the one frame period has passed) (broken arrow).

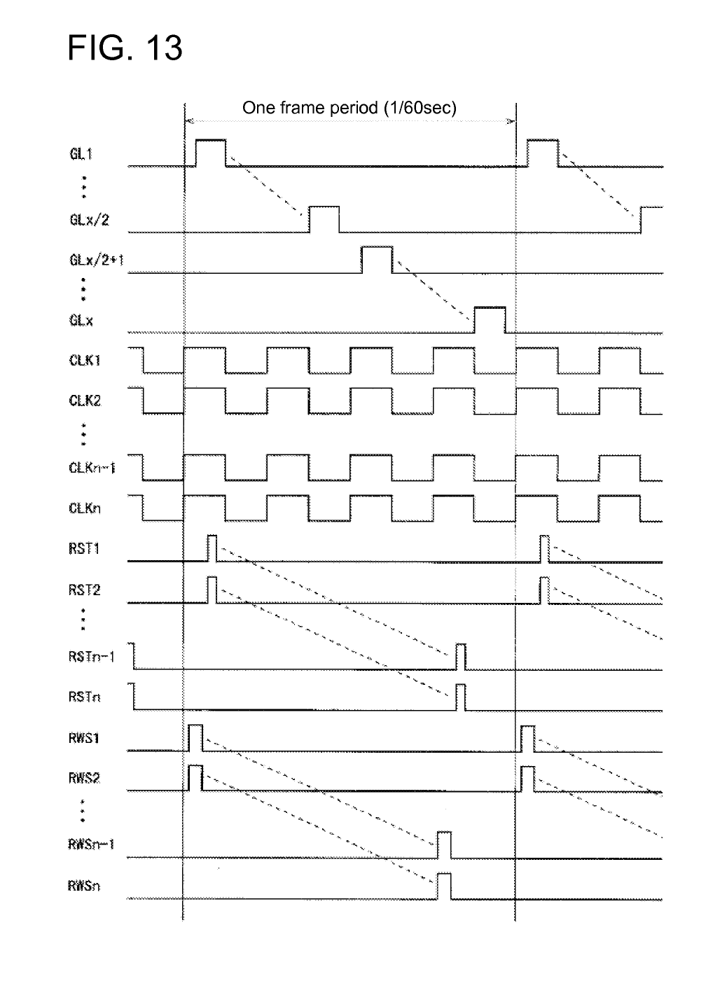

FIG. 13 is a signal waveform chart of the display panel 2. In this example, the potential of the gate lines GL1 to GLx is sequentially increased to a high level for a prescribed length of time, one time each during one frame period. The potentials of the clock lines CLK1 to CLKn are changed in a synchronized manner, and become high-level and low-level four times each during one frame period. Respective two lines of the reset lines RST1 to RSTn are paired with each other, and the potential of the (n/2) pairs of reset lines is sequentially increased to a high level for a prescribed length of time, one time each during one frame period. Respective two lines of the read-out lines RWS1 to RWSn are also paired with each other, and the potential of the (n/2) pairs of read-out lines is sequentially increased to a high level for a prescribed length of time, one time each during one frame period.

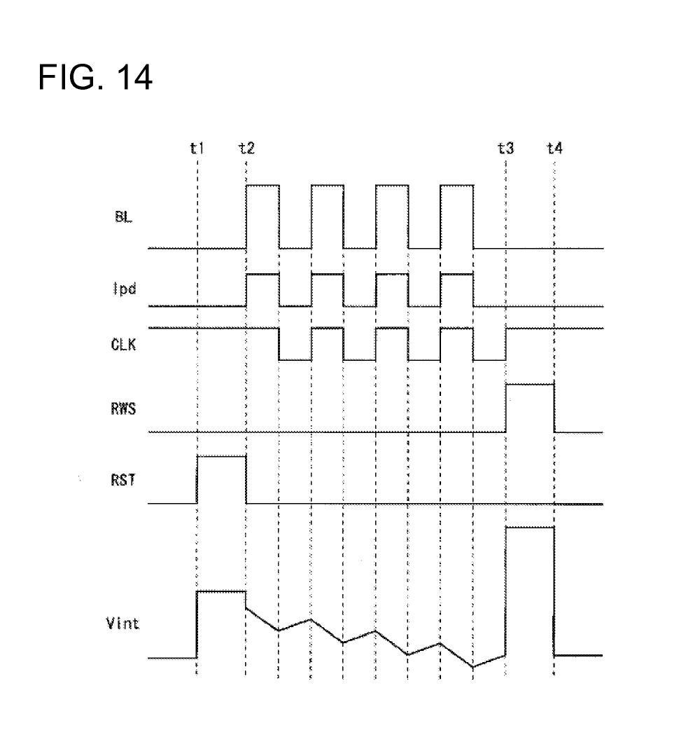

Immediately after the potential of the read-out line RWS1 is changed from the high level to the low level, the potential of the reset line RST1 is increased from the low level to the high level. The potentials of the reset lines RST2 to RSTn are changed in the same manner. Therefore, the length of a period during which the sensor pixel circuits 9 detect light (period between the reset operation and the read-out operation; A0 shown in FIG. 12) becomes almost the same as one frame period. FIG. 14 is a signal waveform diagram of the sensor pixel circuits 9 that are driven by the signals shown in FIG. 13. In FIG. 14, BL denotes the brightness of the backlight 3, Ipd denotes a current flowing through the photodiodes, and Vint denotes a potential of the storage nodes (gate potential of the transistors M1). In FIG. 14, a period from a time t1 to a time t2 becomes the reset period, a period from the time t2 to a time t3 becomes the accumulating period, and a period from the time t3 to a time t4 becomes the read-out period.

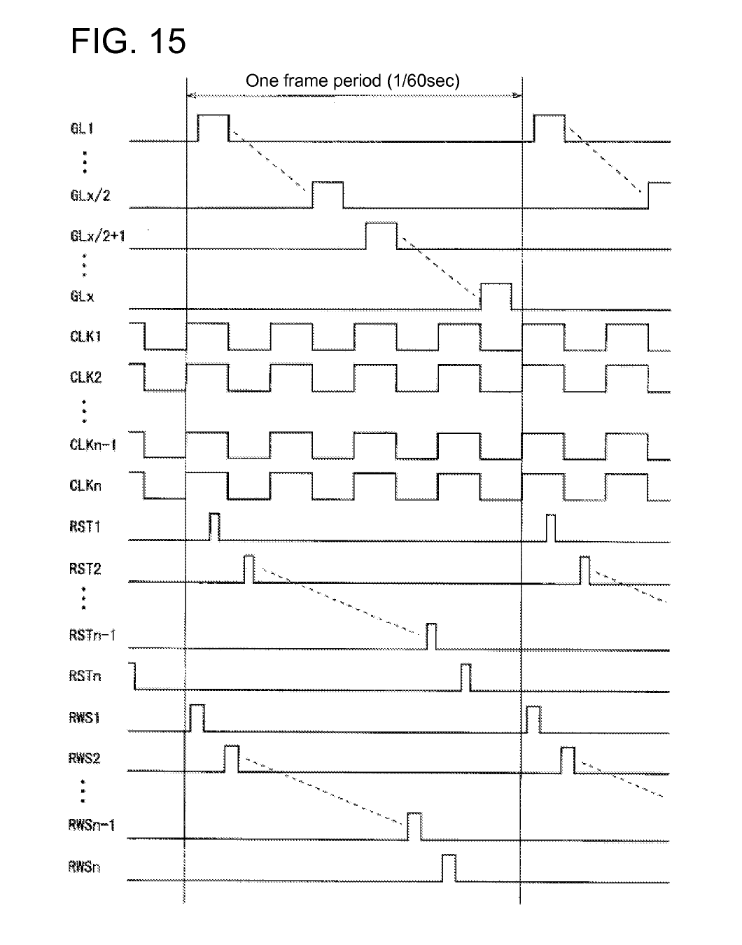

Driving waveforms shown in FIG. 15 may be used instead of the driving waveforms shown in FIG. 13. In an example of FIG. 15, the potential of the gate lines GL1 to GLx is sequentially increased to the high level for a prescribed length of time, one time each during one frame period. The potentials of the clock lines CLK1 to CLKn are changed in a synchronized manner, and become high-level and low-level four times each during one frame period. The high-level period of the potential of the clock lines CLK1 to CLKn and the low-level period thereof are the same in length. The potential of the reset lines RST1 to RSTn is sequentially increased to a high level for a prescribed length of time, one time each during one frame period. The potential of the read-out lines RWS1 to RWSn is also sequentially increased to a high level for a prescribed length of time, one time each during one frame period.

With Embodiment 2 having the above-mentioned configuration, in a manner similar to Embodiment 1, a histogram can be obtained from differences between sensor outputs that correspond to light detected during the detection period during which the backlight is on and sensor outputs that correspond to light detected during the detection period during which the backlight is off, and on the basis of the obtained histogram, a next event that corresponds to an input can be determined.

### INDUSTRIAL APPLICABILITY

The present invention is industrially applicable as a display device having a plurality of optical sensors in a pixel region thereof.

1. A display device that has a plurality of optical sensors in a display region thereof, comprising:
a display panel having a plurality of display pixel circuits and a plurality of sensor pixel circuits;
a sensor signal processing circuit that processes outputs from the sensor pixel circuits;
a light source disposed on a rear surface of the display panel;
a light source control unit that controls the light source such that one frame period in performing an input through the optical sensors includes an ON period of the light source and an OFF period of the light source;
a driver circuit that outputs a first control signal and a second control signal to the sensor pixel circuits and that performs a reset operation and a read-out operation for the sensor pixel circuits, the first control signal instructing a first detection period that includes the ON period of the light source, the second control signal instructing a second detection period that does not include the ON period of the light source;
a difference circuit that derives pixel values that represent differences between outputs from the sensor pixel circuits, which correspond to charges that have been accumulated in accordance with incident light during the first detection period, and outputs from the sensor pixel circuits, which correspond to charges that have been accumulated in accordance with incident light during the second detection period;
a histogram creating unit for extracting a histogram from the pixel values derived by the difference circuit; and
an operation determining unit that determines an operation in accordance with the input through the optical sensors on the basis of the histogram.

2. The display device according to claim 1, wherein the light source is an infrared light source.

3. The display device according to claim 1, wherein the light source is turned on once during one frame period,
wherein the sensor pixel circuits comprise:
a first sensor pixel circuit that is controlled by the first control signal, the first sensor pixel circuit detecting light during a detection period during which the light source is on and holding a detected light amount during other times; and
a second sensor pixel circuit that is controlled by the second control signal, the second sensor pixel circuit detecting light during a detection period during which the light source is off and holding a detected light amount during other times, and
wherein the driver circuit performs the read-out operation for the first sensor pixel circuit and the second sensor pixel circuit sequentially line by line in a period other than the detection period during which the light source is on and other than the detection period during which the light source is off.

4. The display device according to claim 1, wherein the light source is turned on for a prescribed length of time once during one frame period, and
wherein a detection period during which the light source is on and a detection period during which the light source is off are set so as to occur one time each during one frame period.

5. The display device according to claim 4, wherein the driver circuit performs the reset operation for the first sensor pixel circuit at a beginning of the detection period during which the light source is on, and performs the reset operation for the second sensor pixel circuit at a beginning of the detection period during which the light source is off.

6. The display device according to claim 4, wherein the detection period during which the light source is on and the detection period during which the light source is off are the same in length.

7. The display device according to claim 3, wherein the display panel further comprises a plurality of output lines that transfer output signals of the first sensor pixel circuit and the second sensor pixel circuit,
wherein the first sensor pixel circuit and the second sensor pixel circuit are respectively connected to different output lines by typo, and
wherein the driver circuit performs the read-out operation for the first sensor pixel circuit and the read-out operation for the second sensor pixel circuit in parallel.

8. The display device according to claim 1, wherein the driver circuit performs the reset operation for the sensor pixel circuits and the read-out operation for the sensor pixel circuits in parallel sequentially line by line.

9. The display device according to claim 8, wherein the driver circuit performs the reset operation for the sensor pixel circuits and the read-out operation for the sensor pixel circuits one time each during one frame period, the reset operation and the read-out operation being continued for substantially one frame period, respectively.

10. The display device according to claim 9, wherein the driver circuit performs the reset operation for the sensor pixel circuit of one row immediately after the read-out operation for the sensor pixel circuits of the same row is finished.

11. The display device according to claim 1, wherein the operation determining unit derives the number of pixels that have a pixel value that is equal to or greater than a prescribed threshold value, and based on the derived number of pixels, identifies an operation that corresponds to the input through the optical sensors.
